(19) United States
(12) Patent Application Publication
(10) Pub. No.: US 2011/0153892 A1
(43) Pub. Date: Jun. 23, 2011

(54) ACCESS ARBITRATION APPARATUS, INTEGRATED CIRCUIT DEVICE, ELECTRONIC APPARATUS, ACCESS ARBITRATION METHOD, AND PROGRAM

(75) Inventors: Takashi SHINDO, Chino-shi (JP); Takekuni YAMAMOTO, Matsumoto-shi (JP)

(73) Assignee: SEIKO EPSON CORPORATION, Tokyo (JP)

(21) Appl. No.: 12/968,814

(22) Filed: Dec. 15, 2010

(30) Foreign Application Priority Data
Dec. 22, 2009 (JP) 2009-290188

(51) Int. Cl. G06F 13/362

(52) U.S. Cl. 710/113

(57) ABSTRACT

An access arbitration apparatus includes: a group setting information storage section; and an access control section, wherein the group setting information storage section stores group setting information that specifies which of the following groups each of a plurality of masters belongs to, a first group or a second group whose priority is lower than that of the first group, and the access control section identifies an access request source, based on an access request signal from each of the plurality of masters, and repeatedly performs a first group process and a second group process in an alternate manner, the first group process being a process of granting access rights valid for predetermined time to the entire first access request source set, the second group process being a process of granting access rights valid for predetermined time to part of the second access request source set.

The present application claims a priority based on Japanese Patent Application No. 2009-290188 filed on Dec. 22, 2009, the contents of which are incorporated herein by reference.

### BACKGROUND

1. Technical Field

The present invention relates to an access arbitration apparatus, an integrated circuit device, an electronic apparatus, an access arbitration method, and a program.

2. Related Art

In a situation where a plurality of masters issue access requests, an arbitration apparatus is required, for example, to prevent signal collision on a common bus. The arbitration apparatus performs arbitration, for example, by using a polling method, a serial arbitration method (daisy chain method), or a parallel arbitration method.

In a polling method, the access arbitration apparatus sequentially inquires the masters in a rotating manner whether any of them is requesting an access right. When a request is detected, the access arbitration apparatus grants an access right. This method guarantees each of the masters to acquire an access right but is problematic in that no priority is given because all the masters are handled equally.

In a serial arbitration method, an access grant signal is sequentially inputted to the masters in descending order of priority. During the period in which a higher-priority master is requesting access, lower-priority masters cannot acquire access rights. This method is problematic in that the priorities are fixed and a lower-priority master is not guaranteed to acquire an access right.

In a parallel arbitration method, a priority encoder and a priority decoder grant bus use permission to a master in accordance with priority. This method is also problematic in that the priorities are fixed and a lower-priority master is not guaranteed to acquire an access right.

In contrast, the bus arbitration apparatus disclosed in JP-A-10-228446 arbitrates among masters for each bus cycle by sequentially selecting inter-master priority information. According to JP-A-10-228446, the priorities of the masters are not fixed, and a lower-priority master can also acquire an access right.

In JP-A-10-228446, however, a problem occurs when any of the masters requests a large number of bus cycles. In this case, it is practically difficult from a circuit scale point of view to prepare registers for storing all patterns of the priority information.

### SUMMARY

An advantage of some aspects of the invention is to provide an access arbitration apparatus capable of granting access rights appropriately in accordance with the priorities of masters.

A first aspect of the invention is directed to an access arbitration apparatus including a group setting information storage section and an access control section. The group setting information storage section stores group setting information that specifies which of the following groups each of a plurality of masters belongs to, a first group or a second group whose priority is lower than that of the first group. The access control section identifies an access request source, which is a master that is requesting an access right, based on an access request signal from each of the plurality of masters, identifies which of the following access request source set the access request source belongs to based on the group setting information, a first access request source set that belongs to the first group and a second access request source set that belongs to the second group, and repeatedly performs a first group process and a second group process in an alternate manner, the first group process being a process of granting access rights valid for predetermined time to the entire first access request source set, the second group process being a process of granting access rights valid for predetermined time to part of the second access request source set.

According to the first aspect of the invention, the group setting information storage section holds information that specifies which of the following groups a master belongs to, the first group or the second group. The access control section searches the masters to identify an access request source that is requesting access and identifies which of the groups the access request source belongs to based on information from the group setting information storage section. The access control section then grants the access request source an access right at a frequency according to the group to which the access request source belongs. Managing access request sources by grouping them allows necessary circuit scale to be smaller than in a method in which the priorities of the masters are compared one by one.

According to the first aspect of the invention, the access arbitration apparatus can reallocate a master from the first group to the second group or vice versa in accordance with the situations. That is, the priorities of the masters are not fixed but can be flexibly changed.

According to the first aspect of the invention, the access arbitration apparatus grants access rights valid for predetermined time to all the access request sources that belong to the first group (first group process) and then grants access rights valid for predetermined time to part of the access request sources that belong to the second group (second group process). In the second group process, the part of the access request sources may be set to differ from the part of the access request sources in the previous second group process. Since the first group process and the second group process are alternately repeated, a low-priority master that belongs to the second group is guaranteed to acquire an access right.

In the access arbitration apparatus according to the first aspect of the invention, the access control section may grant an access right valid for predetermined time to one of the access request sources in the second access request source set in the second group process.

According to the access arbitration apparatus described above, the second group process is performed on a single access request source, and the second group process then immediately transitions to the first group process. In this way, the rate at which access request sources that belong to the first group have access rights is increased, and access requests issued from a group having higher priority can be completed earlier.

The access arbitration apparatus according to the first aspect of the invention may further include a weighting information storage section. The weighting information storage section may store weighting information that specifies the time over which an access right is granted to the access request source, and the access control section may adjust the time over which an access right is granted to the access request source based on the weighting information.

The access arbitration apparatus described above stores information that specifies the time over which an access right is granted to the access request source (weighting information) in the weighting information storage section. The access control section can adjust the time over which an access right is granted to each access request source based on the weighting information. For example, even when a continuous access request valid for a plurality of cycles and an access request valid for a single cycle are mixed, the access control section grants an access right valid for the time according to each access request source, whereby an access right free of unnecessary actions can be granted.

The access arbitration apparatus described above does not simply follow a weighting (burst-length) request from the access request source but adjusts the time over which an access right is granted based on the weighting information stored in the weighting information storage section. As a result, the access arbitration apparatus prevents a single access request source that is issuing a long-period, continuous access request from keeping an access right and allows the process of granting an access right to be efficiently performed.

The weighting information may directly specify the time over which an access right is granted to each access request source (100 [ms], for example), may set the time on the basis of the cycle of a clock used in the access arbitration apparatus, or may set the time based on a relative proportion to a reference time or a signal.

In the access arbitration apparatus according to the first aspect of the invention, the group setting information storage section may store group setting information that specifies which of the following groups each of the plurality of masters belongs to, the first group, the second group, or a third group whose priority is lower than that of the second group, and the access control section may identify which of the following access request source set the access request source belongs to based on the group setting information, the first access request source set, the second access request source set, or a third access request source set that belongs to the third group and repeatedly perform a third group process of granting access rights valid for predetermined time to the third access request source set only when the access request source that belongs to the first access request source set or the second access request source set is not present.

According to the access arbitration apparatus described above, the group setting information storage section holds information that specifies which of the following groups a master belongs to, the first group, the second group, or the third group. The access control section searches the masters to identify an access request source that is requesting access and identifies which of the groups the access request source belongs to based on information from the group setting information storage section. The access control section then grants the access request source an access right at a frequency according to the group to which the access request source belongs. Managing access request sources by grouping them allows necessary circuit scale to be smaller than in a method in which the priorities of the masters are compared one by one. Further, allocating an access request source whose priority is lower than those of the access request sources in the second group to the third group allows the process of granting an access right to be performed more efficiently.

The access arbitration apparatus described above can reallocate a master that belongs to one of the first, second, and third groups to any of the other groups in accordance with the situations. That is, the priorities of the masters are not fixed but can be flexibly changed.

The access arbitration apparatus described above grants an access right valid for predetermined time to an access request source that belongs to the third group only when the masters that belong to the first or second group are issuing no access request (third group process). The first and second group processes are therefore not affected by the third group process. The access arbitration apparatus can therefore increase overall process efficiency by allocating a low-priority access request source to the third group.

The access arbitration apparatus according to the first aspect of the invention may further include a group setting section, and the group setting section may set the group setting information.

The access arbitration apparatus described above can use the group setting section to change the group setting information. The access arbitration apparatus can therefore immediately rearrange the groups to which the masters belong in accordance with the situations.

The access arbitration apparatus according to the first aspect of the invention may further include a weighting setting section, and the weighting setting section may set the weighting information.

The access arbitration apparatus described above can use the weighting setting section to change the weighting information. The access arbitration apparatus can therefore immediately set again the time over which an access right is granted to the access request source in accordance with the situations.

The access arbitration apparatus according to the first aspect of the invention may further include a process priority information storage section. The process priority information storage section may store process priority information that relates one or more of the plurality of masters to process priorities the number of which is greater than or equal to the total number of the plurality of masters, and the access control section may determine the order in which the access requests that belong to a single group are processed based on the process priority information.

According to the access arbitration apparatus described above, the order in which processes are performed in a single group can be arbitrarily set by determining process priorities in advance and allocating the masters to the process priorities. In this case, access rights can be granted in a variety of orders by accepting a state in which there is no master corresponding to a certain process priority (empty state) or a state in which a single master is allocated to a plurality of process priorities (overlapping state).

In the access arbitration apparatus according to the first aspect of the invention, the weighting information may be so set that the weighting information is related to the process priorities, and the access control section may adjust the time over which an access right is granted to the access request source based on the weighting information that is so set that the weighting information is related to the process priorities.

According to the access arbitration apparatus described above, access rights can be more flexibly granted by weighting the process priorities. For example, when a single master is allocated to process priority 1 and process priority 2, it is possible to grant an access right valid for four cycles of a reference clock for the process priority 1 and an access right valid for two cycles of the reference clock for the process priority 2.

A second aspect of the invention is directed to an integrated circuit device including any of the access arbitration apparatus described above.

The second aspect of the invention is applicable to a greater variety of applications by providing the access arbitration apparatus in the form of semiconductor device or any other integrated circuit.

A third aspect of the invention is directed to an electronic apparatus including the integrated circuit device.

According to the third aspect of the invention, access requests from a plurality of masters are efficiently processed, whereby an electronic apparatus that excels in processing performance can be provided.

A fourth aspect of the invention is directed to an access arbitration method including a group setting step of setting group setting information that specifies which of the following groups each of a plurality of masters belongs to, a first group or a second group whose priority is lower than that of the first group, an identification step of identifying an access request source, which is a master that is requesting an access right, based on an access request signal from each of the plurality of masters, a group identification step of identifying which of the following access request source set the access request source belongs to based on the group setting information, a first access request source set that belongs to the first group and a second access request source set that belongs to the second group, and a group process step of repeatedly performing a first group process and a second group process in an alternate manner, the first group process being a process of granting access rights valid for predetermined time to the entire first access request source set, the second group process being a process of granting access rights valid for predetermined time to part of the second access request source set.

According to the fourth aspect of the invention, the access arbitration method performs the group setting step of specifying which of the following groups a master belongs to, the first group or the second group. The access arbitration method then performs the identification step of searching the masters to identify an access request source that is requesting access and the group identification step of identifying which of the following groups the access request source belongs to based on the group setting information, the first group or the second group. The access arbitration can be processed at higher speed in the access arbitration method than in a method in which the priorities of the masters are compared one by one because the grouping reduces the burden of comparing the priorities.

According to the fourth aspect of the invention, the access arbitration method can reallocate a master from the first group to the second group or vice versa in accordance with the situations. That is, the priorities of the masters are not fixed but can be flexibly changed.

According to the fourth aspect of the invention, the access arbitration method performs the group process step of granting the access request source an access right at a frequency according to the group to which the access request source belongs. In the group process step, the first group process of granting access rights valid for predetermined time to all the access request sources that belong to the first group and the second group process of granting access rights valid for predetermined time to part of the access request sources that belong to the second group are alternately repeated. In the second group process, the part of the access request sources may be set to differ from the part of access request sources in the previous second group process. It is noted that a low-priority master that belongs to the second group is guaranteed to acquire an access right.

In the access arbitration method according to the fourth aspect of the invention, the group setting step may set group setting information that specifies which of the following groups each of the plurality of masters belongs to, the first group, the second group, or a third group whose priority is lower than that of the second group, the group identification step may identify which of the following access request source set the access request source belongs to based on the group setting information, the first access request source set, the second access request source set, or a third access request source set that belongs to the third group, and the group process step may repeatedly perform a third group process of granting access rights valid for predetermined time to the third access request source set only when the access request source that belongs to the first access request source set or the second access request source set is not present.

The access arbitration method described above performs the group setting step of specifying which of the following groups a master belongs to, the first group, the second group, or the third group. The access arbitration method then performs the identification step of searching the masters to identify an access request source that is requesting access and the group identification step of identifies which of the following groups the access request source belongs to based on the group setting information, the first group, the second group, or the third group. The access arbitration can be processed at higher speed in the access arbitration method than in a method in which the priorities of the masters are compared one by one because the grouping reduces the burden of comparing the priorities. Further, allocating an access request source whose priority is lower than those of the access request sources in the second group to the third group allows the process of granting an access right to be performed more efficiently.

The access arbitration method described above can reallocate a master that belongs to one of the first, second, and third groups to any of the other groups in accordance with the situations. That is, the priorities of the masters are not fixed but can be flexibly changed.

The access arbitration method described above grants an access right valid for predetermined time to an access request source that belongs to the third group only when the masters that belong to the first or second group are issuing no access request (third group process). The first and second group processes are therefore not affected by the third group process. The access arbitration method can therefore increase overall process efficiency by allocating a low-priority access request source to the third group.

A fifth aspect of the invention is directed to an access arbitration program that allows a computer to function as a storage unit that stores group setting information that specifies which of the following groups each of a plurality of masters belongs to, a first group or a second group whose priority is lower than that of the first group, and an access control unit that identifies an access request source, which is a master that is requesting an access right, based on an access request signal from each of the plurality of masters, identifies which of the following access request source set the access request source belongs to based on the group setting information, a first access request source set that belongs to the first group and a second access request source set that belongs to the second group, repeatedly performs a first group process and a second group process in an alternate manner, the first group process being a process of granting access rights valid for predetermined time to the entire first access request source set, the second group process being a process of granting access rights valid for predetermined time to part of the second access request source set, and grants the access request source an access right.

According to the fifth aspect of the invention, the group setting step can allocate masters to the first group or the second group, and the access request source identification step can select an access request source that is requesting access from the masters and grant an access right to the access request source at a frequency according to the group to which the access request source is allocated. Since the grouping simplifies the control, the process of granting an access right is performed at higher speed than in a method in which the priorities of the masters are compared one by one for each predetermined cycle.

According to the fifth aspect of the invention, the program can reallocate a master from the first group to the second group or vice versa in accordance with the situations. That is, the priorities of the masters are not fixed. Further, the fifth aspect of the invention, which is a computer program, can be used in a variety of systems.

In the program according to the fifth aspect of the invention, the storage unit, which stores the group setting information, may specify which of the following groups each of the plurality of masters belongs to, the first group, the second group, or a third group whose priority is lower than that of the second group, and the access control unit may identify which of the following access request source set the access request source belongs to based on the group setting information, the first access request source set, the second access request source set, or a third access request source set that belongs to the third group, and repeatedly perform a third group process of granting access rights valid for predetermined time to the third access request source set only when the access request source that belongs to the first access request source set or the second access request source set is not present.

According to the program described above, the group setting step can allocate masters to the first group, the second group, or the third group, and the access request source identification step can select an access request source that is requesting access from the masters and grant an access right to the access request source at a frequency according to the group to which the access request source is allocated. Since the grouping simplifies the control, the process of granting an access right is performed at higher speed than in a method in which the priorities of the masters are compared one by one for each predetermined cycle. Further, a low-priority access request source can be efficiently allocated to the third group, which is accessed at a lower frequency.

The program described above can reallocate a master that belongs to one of the first, second, and third groups to any of the other groups in accordance with the situations. That is, the priorities of the masters are not fixed. Since the third group process is performed only when the masters that belong to the first or second group are issuing no access request, the first and second group processes are not affected by the third group process. Rather, overall process efficiency can be increased by allocating a low-priority access request source to the third group. Further, the embodiment of the fifth aspect of the invention, which is a computer program, can be used in a variety of systems.

### BRIEF DESCRIPTION OF THE DRAWINGS

The invention will be described with reference to the accompanying drawings, wherein like numbers reference like elements.

FIG. 1 is a block diagram of an access arbitration apparatus in a first embodiment.

FIG. 2 is a block diagram showing how the access arbitration apparatus in the first embodiment is connected.

FIG. 3 shows how the access arbitration apparatus identifies groups and determines the order in which processes are performed in each of the groups in the first embodiment.

FIG. 4A is a table showing the relationship among masters, groups, and other parameters involved in the access arbitration apparatus in the first embodiment, and FIG. 4B is a timing chart showing the order in which the access arbitration apparatus performs processes in the first embodiment.

FIG. 5 is a block diagram showing an access arbitration apparatus and an example of how the access arbitration apparatus is connected in a second embodiment.

FIG. 6A is a table showing the relationship among masters, groups, and other parameters in an access arbitration apparatus in the second embodiment, and FIG. 6B is a timing chart showing the order in which the access arbitration apparatus performs processes in the second embodiment.

FIG. 7 is a block diagram showing an access arbitration apparatus and an example of how the access arbitration apparatus is connected in a third embodiment.

FIG. 8 shows how the access arbitration apparatus identifies groups and determines the order in which processes are performed in each of the groups in the third embodiment.

FIG. 9A is a table showing the relationship among masters, groups, and other parameters in an access arbitration apparatus in the third embodiment, and FIG. 9B is a timing chart showing the order in which the access arbitration apparatus performs processes in the third embodiment.

FIG. 10 is a block diagram showing an integrated circuit device, an access arbitration apparatus, and an example of how the components in the integrated circuit device are connected in a fourth embodiment.

FIG. 11 shows input/output signals from and to the access arbitration apparatus included in the integrated circuit device in the fourth embodiment.

FIG. 12 is a table showing the relationship among process priorities, masters, and other parameters in the access arbitration apparatus included in the integrated circuit device in the fourth embodiment.

FIG. 13A is a table shown in FIG. 12 but rearranged on a group basis, and FIG. 13B is a timing chart showing the order in which processes are performed in the access arbitration apparatus included in the integrated circuit device in the fourth embodiment.

FIG. 14 is a block diagram of an electronic apparatus in a fifth embodiment.

FIG. 15A shows a mobile phone, which is an example of the electronic apparatus, FIG. 15B shows a mobile game console, which is an example of the electronic apparatus, and FIG. 15C shows a personal computer, which is an example of the electronic apparatus.

FIG. 16 shows a projector, which is an example of the electronic apparatus.

FIG. 17 is a flowchart showing an access arbitration method corresponding to the access arbitration apparatus in the first embodiment.

FIG. 18 is a flowchart showing an access arbitration method corresponding to the access arbitration apparatus in the third embodiment.

FIGS. 19A to 19C are flowcharts showing part of the processes used in FIGS. 17 and 18.

### DESCRIPTION OF EXEMPLARY EMBODIMENTS

Embodiments of the invention will be described below with reference to the drawings. In the description of a second embodiment and the following embodiments, the same components as those in a first embodiment have the same reference characters, and no description of these components will be made.

### 1. First Embodiment

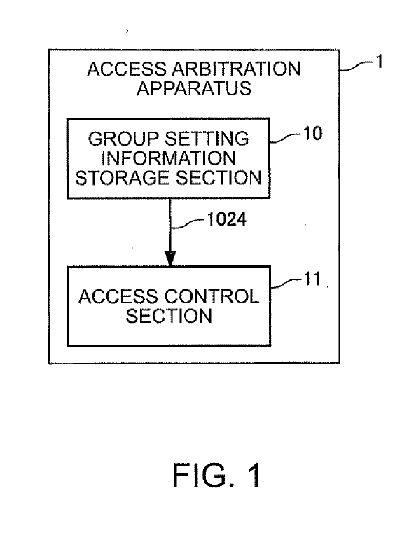

A first embodiment of the invention will be described with reference to FIGS. 1, 2, 3, 4A, and 4B.

FIG. 1 is a block diagram of an access arbitration apparatus 1 of the present embodiment. The access arbitration apparatus 1, which arbitrates access requests from a plurality of masters, includes a group setting information storage section 10 and an access control section 11. The access control section 11 receives group setting information 1024 from the group setting information storage section 10 and uses it in arbitration control.

The group setting information storage section 10 stores group setting information that specifies which group, a first group or a second group, each of the masters belongs to. A master that issues a request having lower priority than those of the masters that belong to the first group, that is, a request for a less important process (access) in the system, may be allocated to the second group. The group setting information storage section may store the group setting information in a register that, for example, relates a master name to a group to which the master belongs. Process performing efficiency in the system as a whole can be increased by preferentially processing an access request from the first group based on the group setting information.

The group setting information may be set or updated, for example, by a CPU or any other suitable component external to the access arbitration apparatus 1, or the access arbitration apparatus 1 may have a function of setting or updating the group setting information.

The access control section 11 grants an access right valid for predetermined time to a master selected in accordance with the priority between the groups and the priority among the masters.

The first group has higher priority than the second group. The access control section 11 grants access rights valid for predetermined time to a first access request source set formed of all access request sources that belong to the first group (first group process). The access control section 11 then grants an access right valid for predetermined time to a second access request source set formed of part of the access request sources that belong to the second group (second group process). The time over which an access right is granted may be fixed time determined in advance (100 msec, for example) or may be based on the cycle of a clock inputted to the access arbitration apparatus 1 (four cycles, for example). The time may vary for each access request source. Further, the time over which an access right is granted is not necessarily fixed but may vary at fixed or specific timing.

The priority among the masters determines the order in which the process of granting an access right is performed in a single group. For example, the access control section 11 may grant access rights in ascending order of channel number of the access request sources allocated to a single group. In this example, when the time over which an access right is granted is fixed, the access right is granted in a round-robin fashion in the single group. An access right is therefore granted to a lower-priority access request source in a fixed period.

In the present embodiment, the access control section 11 grants an access request source an access right valid only for limited time in the order according to the priority among the masters in a single group. The time over which an access right is granted is not necessarily be fixed (in a round-robin fashion).

The access control section 11 alternately repeats the first group process and the second group process. In the first group process, access rights are granted sequentially to all the access request sources that belong to the first group, whereas in the second group process, access rights are granted to part of the access request sources that belong to the second group. The access request sources that belong to the first group can therefore complete their access requests early because access rights are frequently granted to them. That is, not only is the first group process performed before the second group process, but also access request sources that belong to the first group have precedence over the second group in terms of frequency at which access rights are granted.

The number of part of the access request sources in the second group process is one in the present embodiment, although essentially not limited to one. In this case, after an access right is granted to a single access request source that belongs to the second group in the second group process, an access right is not granted to another access request source that belongs to the second group, but the first group process is initiated. Since access rights are therefore most frequently granted to access request sources that belong to the first group, processes performed on the first group has the highest precedence.

It is noted that an access right is not granted to each of the access request sources that belong to the second group in a single second group process. Instead, an access right is granted in the second group process to an access request source having the second highest priority that is immediately lower than that of the access request source to which an access right has been granted in the previous second group process. In a situation where an access right has been granted to an access request source having the lowest priority in the previous second group process, an access right may be granted to an access request source having the highest priority because the process of granting an access right is performed in a rotating manner. When the number of part of the access request sources in the second group process is two or greater, the process is similarly performed in accordance with the priorities of the masters that belong to the second group.

In the present embodiment, the access arbitration apparatus 1 has updatable group setting information in the group setting information storage section 10 and can flexibly change the priority among the masters. Further, since the access arbitration apparatus 1 grants an access request source an access right valid only for limited time, lower-priority masters that belong to the second group can also acquire access rights.

Further, in the present embodiment, the second group process is performed on a single access request source. As a result, after an access right is granted to a single access request source that belongs to the second group in the second group process, the first group process is immediately initiated. The rate at which access request sources that belong to the first group have access rights is increased, and access requests issued from a group having higher priority can be completed earlier.

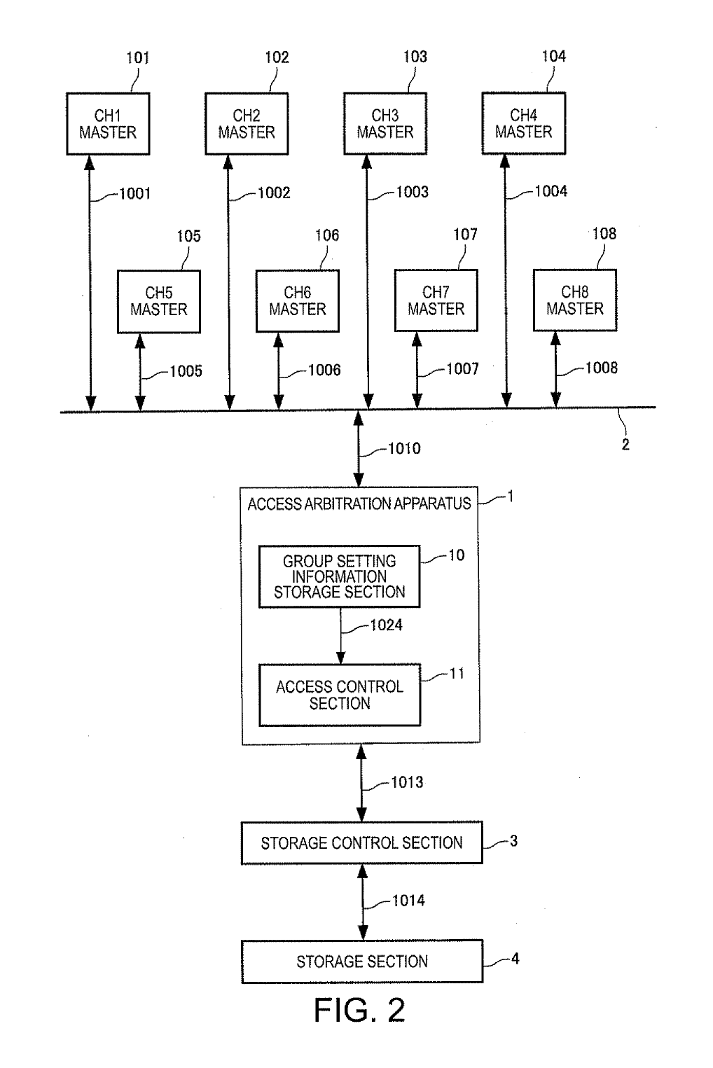

FIG. 2 shows an example of how the access arbitration apparatus 1 is connected in the present embodiment. The same components as those in FIG. 1 have the same reference characters, and no description of these components will be made.

The access arbitration apparatus 1 inputs or outputs input/output signals 1010 from or to eight masters. Part of the input/output signals 1010 is inputted from or outputted to a bus 2, and the remaining signals are inputted from or outputted to the masters as input/output signals 1001 to 1008. That is, FIG. 2 means that part of the input/output signals 1010 to and from the access arbitration apparatus 1 is directly inputted/outputted as the input/output signals 1001 to 1008 to and from the masters and does not mean that all the signals that form the input/output signals 1010 or the input/output signals 1001 to 1008 go through the bus 2.

The system including the access arbitration apparatus 1 of the present embodiment further includes masters 101 to 108 labeled with CH1 (channel 1) to CH8 (channel 8). In the following description, CH1 (channel 1) master 101 is abbreviated to CH1, and the same abbreviation scheme applies to the other masters from the CH2 master 102 to the CH8 master 108. The input/output signals from and to CH1 to CH8 are labeled with 1001 to 1008. As described above, part of the input/output signals 1001 to 1008 is inputted from or outputted to the bus 2, and the remaining signals are directly inputted from or outputted to the access arbitration apparatus 1 as the input/output signals 1010.

CH1 to CH8 access data stored in a storage section 4 via a storage control section 3. The storage section 4 may be an SRAM, a DRAM, a flash memory, or any other suitable memory or an HDD or any other suitable storage device. The storage control section 3 and the storage section 4 use input/output signals 1014 to perform input/output operation. The access arbitration apparatus 1 inputs or outputs address signals, data signals, and other signals having undergone an arbitration process as input/output signals 1013 from and to the storage control section 3. In the arbitration process, the access arbitration apparatus 1 arbitrates access requests issued from CH1 to CH8 and directed to the storage section 4 to prevent signal collision on the bus 2. In the arbitration process, the access arbitration apparatus 1 appropriately grants access rights to CH1 to CH8 in consideration of the priorities of processes in the system.

The input/output signals 1001 to 1008 from and to CH1 to CH8 include addresses, input/output data, access request signals, and access grant signals. The access grant signals are outputted from the access arbitration apparatus 1, and CH1 to CH8 will not output addresses or other data until the access grant signals are inputted to CH1 to CH8. Among the data contained in the input/output signals 1001 to 1008, the addresses and the input/output data desirably go through bus 2. The reason for this is that the addresses and the input/output data can be used also in access to devices (not shown) other than the storage section 4 or access between the masters CH1 to CH8. Each of CH1 to CH8, which are masters, issues a request for access to the storage section 4 at arbitrary timing. The access arbitration apparatus 1 therefore needs to perform arbitration to prevent signal collision on the bus 2 in the present embodiment.

In the present embodiment, the access request signals and the access grant signals are used only between the CH1 to CH8 and the access arbitration apparatus 1, and the two signals are inputted from CH1 to CH8 to the access arbitration apparatus 1 and outputted from the access arbitration apparatus 1 to CH1 to CH8 without going through the bus 2 (1001 to 1008, and 1010). The access request signal is enabled when any of CH1 to CH8 requests access to the storage section 4 and is inputted from the corresponding one of CH1 to CH8 to the access arbitration apparatus 1. The access arbitration apparatus 1 recognizes the master that enables the access request signal as an access request source. When a plurality of masters are access request sources, the arbitration described with reference to FIG. 2 is performed to prevent signal collision on the bus 2, and an access grant signal is outputted to a master to which an access right is granted. Among CH1 to CH8, the master that has received the access grant signal inputs/outputs an address signal, a data signal, or any other signal via the bus 2.

For, example, when CH2 issues a request to read the storage section 4, CH2 receives an access grant signal and outputs an address signal to the access arbitration apparatus 1 via the bus 2 (1002 and 1010). The access arbitration apparatus 1 outputs the address signal to the storage control section 3 (1013). The storage control section 3 outputs the address signal to the storage section 4 and receives data in the area specified by the address (1014). The storage control section 3 outputs the data to the access arbitration apparatus 1 (1013). The access arbitration apparatus then outputs the data to CH2 via the bus 2 (1010 and 1002).

In the present embodiment, data go through the bus 2 even when the data are written to the storage section 4, but any other suitable configuration may be used. As will be describe later in another embodiment, data to be written from CH1 to CH8 to the storage section 4 may be separately inputted to the access arbitration apparatus 1, whereas data read from the storage section 4 may go through the bus 2. In this case, since the data to be written will not collide with each other on the bus 2, CH1 to CH8 can output the data to be written without waiting for access grant signals, and the access arbitration apparatus 1 can control the system by using an ACK (ACKnowledgement) signal in place of the access grant signal. That is, when the access arbitration apparatus 1 outputs data to be written to the storage control section 3 or outputs data having been read to the bus 2, the access arbitration apparatus 1 informs the access request source of the completion of the access process by using the ACK signal. Further, the access arbitration apparatus 1 and the storage control section 3 are separate functional blocks in the present embodiment, but the storage control section 3 may alternatively include the access arbitration apparatus 1, as in another embodiment described later.

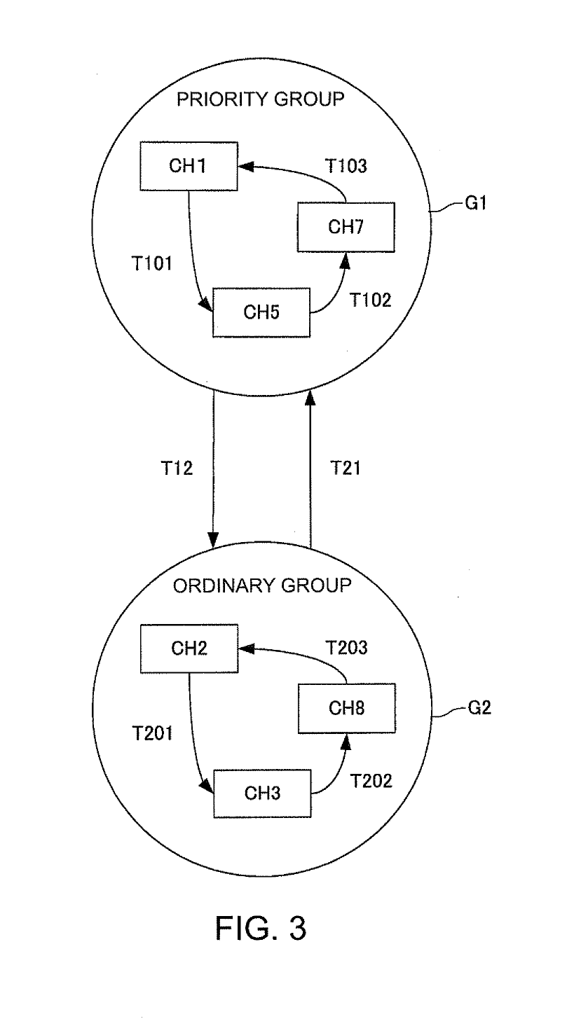

FIG. 3 shows how the access arbitration apparatus identifies groups and determines the order in which processes are performed in each of the groups in the present embodiment. A specific example of arbitration performed by the access arbitration apparatus 1 will be described with reference to FIG. 3.

FIG. 3 shows the order in which processes are performed on access request sources that belong to a priority group G1 or an ordinary group G2, that is, the order in which the access control section 11 grants access rights. The priority group G1 is the first group described above, and the ordinary group G2 is the second group described above. A set of access request sources that belong to the priority group G1 is the first access request source set, and a set of access request sources that belong to the ordinary group G2 is the second access request source set. The first access request source set or the second access request source set can be an empty set having no access request source that belongs thereto. An access request from a master that belongs to the priority group G1 has precedence over an access request from a master that belongs to the ordinary group G2 and is processed accordingly. It is noted that a master that is issuing an access request is referred to as an access request source. CH1 to CH8 shown in FIG. 3 correspond to the CH1 master 101 to the CH8 master 108 shown in FIG. 2.

Access request sources that belong to the priority group G1 are CH1, CH5, and CH7, and access request sources that belong to the ordinary group G2 are CH2, CH3, and CH8. CH4 and CH6 may belong to either of the groups but do not undergo the arbitration performed by the access arbitration apparatus 1 because they are issuing no access request. FIG. 3 therefore does not show CH4 or CH6.

In the present embodiment, it is assumed that the access control section 11 grants access rights to access request sources in a single group in ascending order of the channel number assigned to them. The time over which an access right is granted is expressed in units of cycles of a clock (hereinafter also referred to as CLK) inputted to the access arbitration apparatus 1 and assumed to be four cycles in the present embodiment.

The first group process is a process of granting access rights sequentially to CH1, CH5, and CH7, which belong to the priority group G1. The second group process is a process of granting an access right to part of CH2, CH3, and CH8, which belong to the ordinary group G2. In the present embodiment, the “part” stands for a single access request source. When the first group process is completed, the group to which access rights are granted transitions to the ordinary group G2 so that the second group process can be performed (T12). When the second group process is completed, the group to which access rights are granted transitions to the priority group G1 so that the first group process is performed again (T21).

The order in which the access control section 11 grants access rights in the example shown in FIG. 3 is specifically shown below. First, the access control section 11 sequentially grants access rights to CH1, CH5, and CH7 in the first group process performed on the priority group G1 (T103, T101, and T102). Since access rights have been granted to all the access request sources that belong to the priority group G1, the first group process is completed, and the internal state of the access control section 11 transitions (T12). The access control section 11 then grants an access right to CH2 in the second group process performed on the ordinary group G2 (T203). Since an access right has been granted to one of the access request sources that belong to the ordinary group G2, the second group process is completed, and the internal state of the access control section 11 transitions (T21). The access control section 11 again sequentially grants access rights to CH1, CH5, and CH7 in the first group process (T103, T101, and T102). The internal state of the access control section 11 then transitions (T12). The access control section 11 grants an access right to CH3 (T201) instead of CH2, to which an access right has been granted in the previous second group process. Since the second group process is completed, the access control section 11 performs the first group process again (T21, T103, T101, and T102). In the following second group process, an access right is granted to CH8 (T202).

The access control section 11 repeats the first group process and the second group process, as described above. The access request source that has undergone an access process is removed from those that will undergo the first group process or the second group process. The first group process and the second group process are repeated until all access processes are completed.

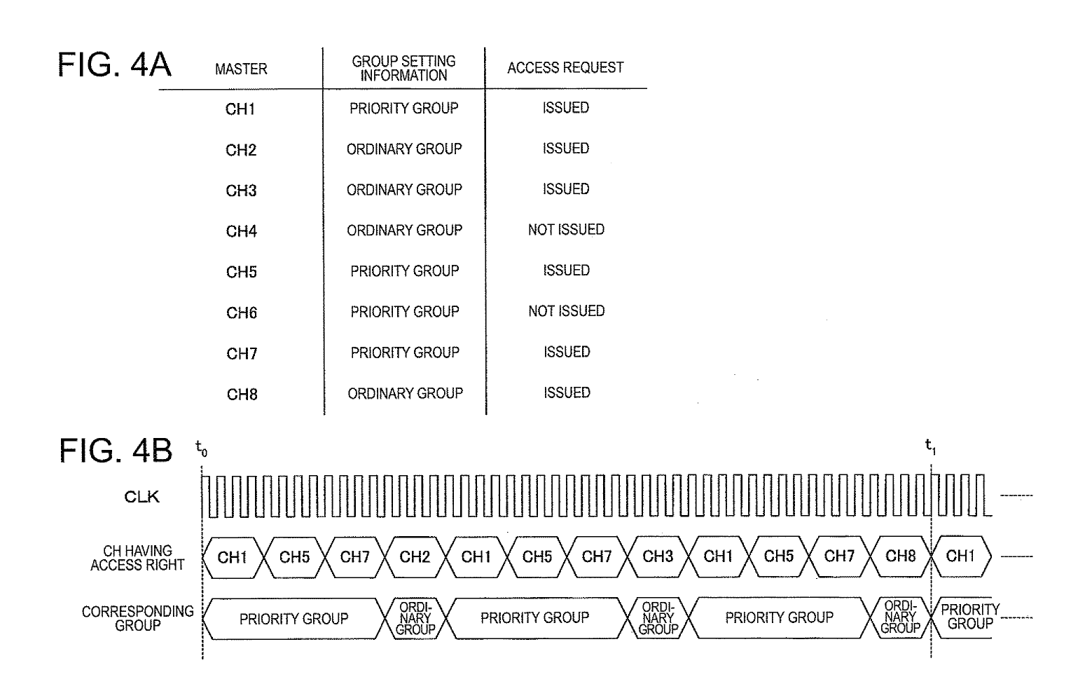

FIG. 4A is a table showing the groups to which the masters belong and whether or not access requests have been issued in the example shown in FIG. 3. CH4 and CH6, which belong to the ordinary group and the priority group, respectively, are removed from those that will undergo the first group process or the second group process because CH4 and CH6 are issuing no access request. The other masters are requesting access rights, and the groups to which they belong are shown in FIG. 3.

FIG. 4B is a waveform chart showing how masters having access rights transition. In FIG. 4B, masters having access rights are labeled with their channel (CH) numbers, and the groups to which the masters belong are shown below the channel numbers. CLK represents the clock inputted to the access arbitration apparatus 1, as described above. The access control section 11 sequentially grants access request sources access rights valid for four cycles of CLK.

In FIG. 4B, the order in which a master to which an access right is granted transitions to another is the same as that described with reference to FIG. 3. The access control section 11 repeats the first group process and the second group process. The access control section 11 grants access rights to all the access request sources that belong to the priority group in the first group process. On the other hand, the access control section 11 grants an access right to part of the access request sources that belong to the ordinary group in the second group process. Since the frequency at which an access right is granted differs between the priority group and the ordinary group, an access request from the priority group has precedence over that from the ordinary group and is processed accordingly. For example, an access right is granted to CH1, which belongs to the priority group, three times during the period from time t₀ to t₁, whereas an access right is granted to CH2, which belongs to the ordinary group, only once. The frequency at which an access right is granted thus differs in accordance with the priorities of the groups.

### 2. Second Embodiment

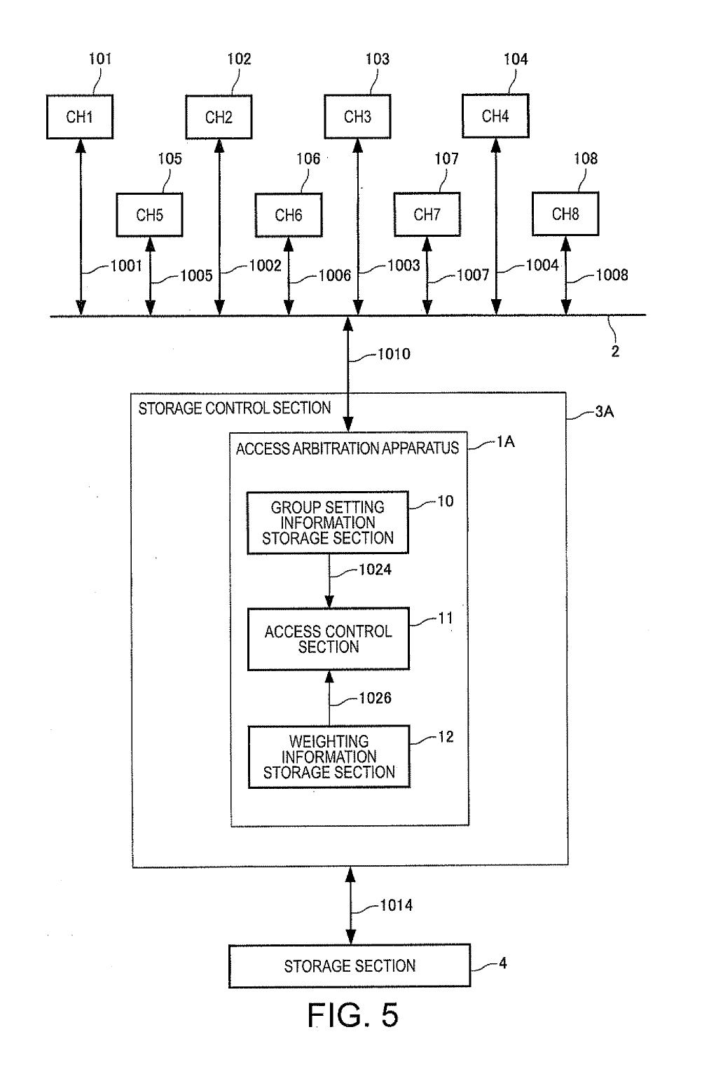

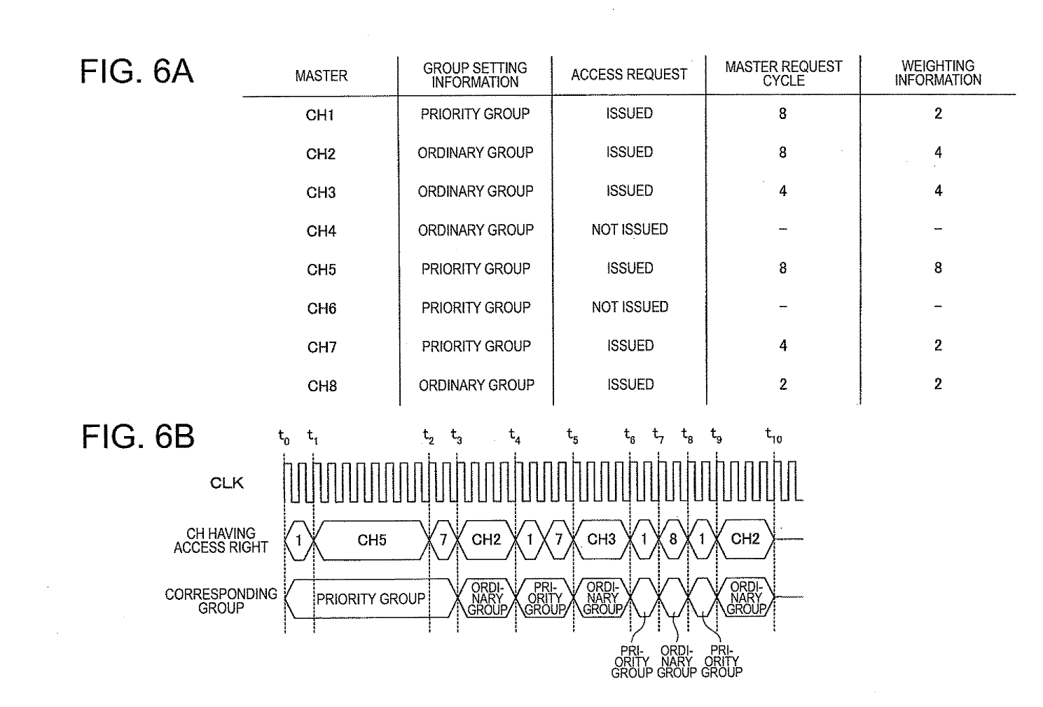

A second embodiment of the invention will be described with reference to FIGS. 5, 6A, and 6B. The same components as those in the first embodiment have the same reference characters, and no description of these components will be made. Instead, differences between the first embodiment and the second embodiment will primarily be described.

FIG. 5 is a block diagram including an access arbitration apparatus 1A of the present embodiment. The access arbitration apparatus 1A arbitrates requests from a plurality of masters CH1 to CH8 (101 to 108) for access to the storage section 4, as in the first embodiment. The present embodiment differs from the first embodiment in that the access arbitration apparatus 1A is part of a storage control section 3A. The present embodiment further differs from the first embodiment in that the access arbitration apparatus 1A includes a weighting information storage section 12.

The weighting information storage section 12 stores weighting information 1026 that specifies the time over which the access control section 11 grants an access right. The access control section 11 can grant an access right valid for the time according to a master in question by using the weighting information 1026.

For example, assume that CH5 and CH7, which are access request sources, are issuing burst write requests valid for eight cycles and four cycles, respectively, to the storage section 4. Also assume that CH5 and CH7 belong to the priority group and the access request from CH5 has higher priority than the access request from CH7. If the access control section 11 grants CH5 and CH7 the same access right valid for four cycles of CLK, the process for CH5, which has higher priority, is completed later. In this case, it is preferable from the viewpoint of process efficiency in the system to adjust the time over which a single access right is granted for each of the masters. The weighting information storage section 12 passes the weighting information 1026 to the access control section 11 so that the time over which an access right is granted can be adjusted in accordance with an access request source.

FIG. 6A is a table showing an example of groups to which masters belong (group setting information), whether or not access requests have been issued, the number of necessary cycles in the access requested by a master (master request cycle), and weighting information. The groups to which masters belong and whether or not access requests have been issued are the same as those in the example shown in FIG. 4A, and no description thereof will be made. In this example, the master request cycle represents the number of cycles necessary in the access requested by an access request source. For example, CH1 is requesting burst access valid for eight cycles. The weighting information specifies the time over which an access right is granted to an access request source, as described above. In this example, the weighting information is expressed on a CLK cycle basis, as in the case of the master request cycle. For example, the CH1 master is requesting access valid for eight cycles, but the access arbitration apparatus 1A, which is a slave, sets the time over which a single access right is granted to be two cycles based on the weighting information from the weighting information storage section 12. The access arbitration apparatus 1A does not simply grant an access right in accordance with a master request cycle but can adjust the time over which the access right is granted based on the weighting information 1026. As a result, the access arbitration apparatus 1A prevents a specific access request source from occupying the bus and other components and allows a lower-priority access request source to acquire an access right. Further, the access control section grants an access right valid for the time appropriate for each access request source, whereby an efficient process free of unnecessary actions can be performed in the overall system.

FIG. 6B is a waveform chart showing a case where the access control section 11 grants access rights based on the weighting information 1026. The signals in FIG. 6B are the same as those shown in FIG. 4B, and no description thereof will be made.

The access control section 11 first performs the first group process on the priority group. CH1 acquires an access right valid for two cycles based on the weighting information (t₀ to t₁). CH5, which is going to acquire an access right next, acquires an access right valid for eight cycles (t₁ to t₂), which differs from the access right granted to CH1. CH5, which has requested a master request cycle valid for eight cycles and has actually performed access for eight cycles, completes the access request. The priority of CH5 is lower than that of CH1, but weighting information can be set to each of the masters irrespective of the priorities. The access control section 11 then grants CH7 an access right valid for two cycles in the first group process (t₂ to t₃).

The access control section 11 then performs the second group process on the ordinary group. CH2 acquires an access right valid for four cycles (t₃ to t₄). Weighting information can be set to each of the masters irrespective of the group to which the master belongs.

The access control section 11 then performs the first group process on the priority group again. Since the access process requested by CH5 has been completed, the access control section 11 grants CH1 and CH7 access rights (t₄ to t₅). CH7, which has requested a master request cycle valid for four cycles, completes the requested access process. The access control section 11 subsequently performs the second group process on. CH3 (t₅ to t₆), the first group process on CH1 (t₆ to t₇), the second group process on CH8 (t₇ to t₃), the first group process on CH1 (tₐ to t₉), and the second group process on CH2 (t₉ to t₁₀). In each of the processes, the time over which an access right is granted follows the weighting information assigned to the corresponding master.

### 3. Third Embodiment

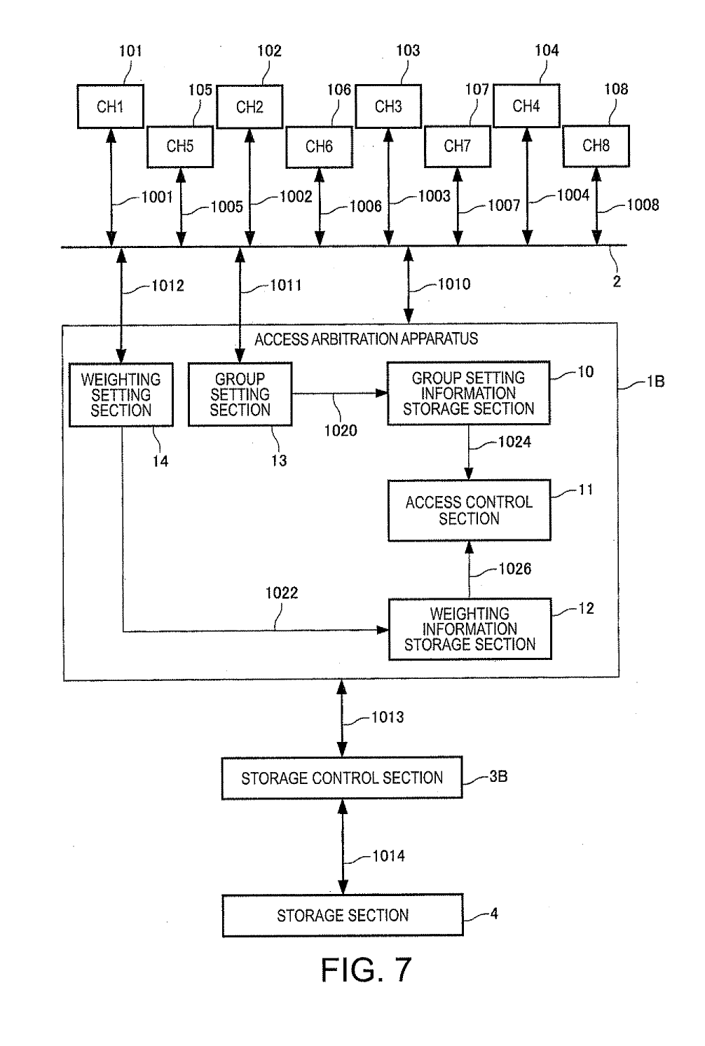

A third embodiment of the invention will be described with reference to FIGS. 7, 8, 9A, and 9B. The same components as those in the first and second embodiments have the same reference characters, and no description of these components will be made. Instead, differences between the third embodiment and the first and second embodiments will primarily be described.

FIG. 7 is a block diagram including an access arbitration apparatus 1B of the present embodiment. The access arbitration apparatus 1B arbitrates requests from a plurality of masters CH1 to CH8 (101 to 108) for access to the storage section 4, as in the second embodiment. In the present embodiment, the access arbitration apparatus 1B and a storage control section 3B input or output the input/output signals 1013, as in the first embodiment. In the present embodiment, a group setting section 13 writes group setting information 1020 to the group setting information storage section 10, and a weighting setting section 14 writes weighting information 1022 to the weighting information storage section 12.

For example, the group setting section 13 and the weighting setting section 14 may be functional blocks that are not masters (but are slaves) and input or output input/output signals 1011 and input/output signals 1012, respectively, from or to the bus 2. Alternatively, the group setting section 13 and the weighting setting section 14 may not be slave functional blocks included in the access arbitration apparatus 1B but may be included in each master, such as a CPU, or part of the functions of each master.

Each master, such as a CPU, may update the group setting information stored in the group setting information storage section 10 via the group setting section 13. The group setting information may be updated at a variety of points of time, for example, at fixed intervals or after a certain event. The access arbitration apparatus 1B can flexibly change the group setting information by using the group setting section 13. The access arbitration apparatus 1B can therefore improve process efficiency by allocating each master to an optimum group in accordance with the situations.

Further, a master, such as a CPU, may update the weighting information stored in the weighting information storage section 12 via the weighting setting section 14. The weighting information may be updated at a variety of points of time, as in the case of the group setting section 13. The access arbitration apparatus 1B can flexibly change the weighting information by using the weighting setting section 14. The access arbitration apparatus 1B can therefore improve the process efficiency by granting an access request source an access right valid for optimum time in accordance with the situations.

The group setting information storage section 10 in the access arbitration apparatus 1B of the present embodiment has not only the same priority group and ordinary group as those in the first and second embodiments but also a third group referred to as a subordinate group.

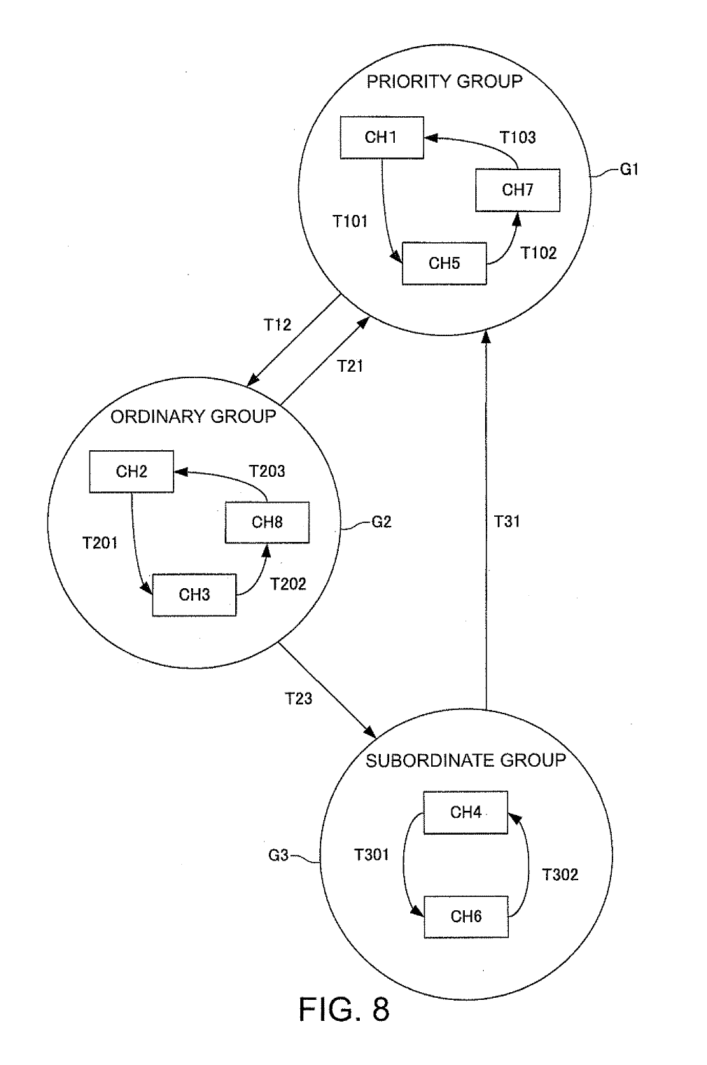

FIG. 8 shows how the access arbitration apparatus 1B identifies groups and determines the order in which processes are performed in each of the groups in the present embodiment. A specific example of arbitration performed by the access arbitration apparatus 1B will be described with reference to FIG. 8.

FIG. 8 shows the order in which processes are performed on access request sources that belong to the priority group G1, the ordinary group G2, or the subordinate group G3, that is, the order in which the access control section 11 grants access rights. The subordinate group G3 is a third group to which masters to be processed after those in the priority group G1 and the ordinary group G2 belong. A set of access request sources that belong to the subordinate group G3 is a third access request source set. The third access request source set can be an empty set having no access request source that belongs thereto. An access request from a master that belongs to the subordinate group G3 is processed only when no master that belongs to the priority group G1 or the ordinary group G2 is issuing an access request. CH1 to CH8 shown in FIG. 8 correspond to CH1 to CH8 shown in FIG. 7.

Access request sources that belong to the priority group G1 are CH1, CH5, and CH7. Access request sources that belong to the ordinary group G2 are CH2, CH3, and CH8. Access request sources that belong to the subordinate group G3 are CH4 and CH6. It is assumed that all the masters CH1 to CH8 issue access rights.

Processes performed on the priority group G1 and the ordinary group G2 (first group process and second group process) are the same as those shown in FIG. 3 including the transition between the groups, and no description of the processes and transition will be made. The access control section 11 performs a third group process on the subordinate group G3. The third group process is a process of granting access rights to CH4 and CH6, which belong to the subordinate group G3. The third group process is performed only when all access requests from access request sources that belong to the priority group or the ordinary group have been completed. For example, during the period in which the second group process is performed on CH8 in the ordinary group, the third group process will not be performed. Even after the third group process is initiated and being performed, the third group process is terminated when an access request source that belongs to the priority group or the ordinary group issues an access request, and the first group process or the second group process is performed. After the access process requested by the access request source that belongs to the priority group or the ordinary group is completed, the third group process is resumed.

The order in which the access control section 11 grants access rights in the example shown in FIG. 8 is specifically shown below. The access control section 11 first performs the first group process on the priority group G1 and the second group process on the ordinary group G2 and repeats the two processes. No description thereof will be made because the processes described above are the same as those shown in FIG. 3. When the first group process and the second group process are completed, that is, when no access request is issued from the masters that belong to the priority group G1 or the ordinary group G2, an access right is granted to a master that belongs to the subordinate group (T23). The access control section 11 sequentially grants access rights to CH4 and CH6 in the third group process (T302 and T301). It is assumed, as in the example shown in FIG. 3, that a master having a smaller channel number has precedence over a master having a greater channel number in a single group. When a master that belongs to the priority group or the ordinary group issues an access request during the period in which the third group process is being performed, the access control section 11 changes its internal condition (T31) and performs the first group process or the second group process in accordance with the request.

The subordinate group G3 is a group to which a master that issues an access request whose priority is so low that it is unnecessary to abort the first group process or the second group process is suitably allocated.

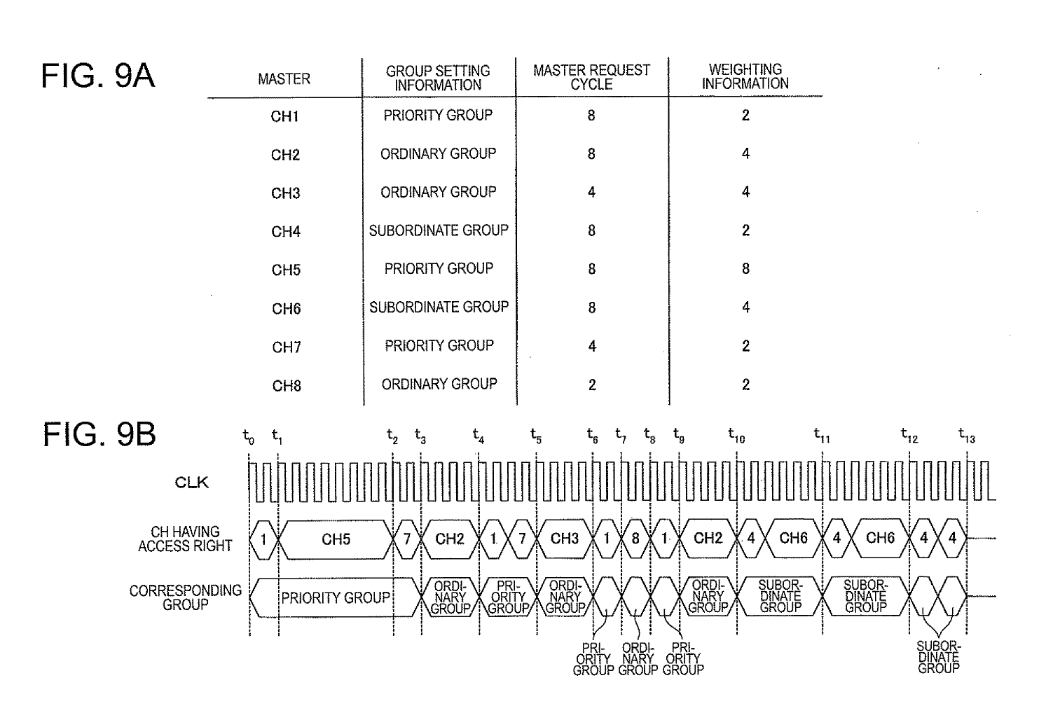

FIG. 9A is a table showing an example of groups to which masters belong (group setting information), the number of necessary cycles in the access requested by a master (master request cycle), and weighting information. The items described above are the same as those in the example shown in FIG. 6A, and no description thereof will be made. It is assumed in FIG. 9A that all the masters are issuing access requests. In this example, the masters other than CH4 and CH6 have the same states as those shown in FIG. 6A, CH4 and CH6 belong to the subordinate group (third group). The master request cycle requested by CH4 and CH6 is eight. The access control section 11, however, grants an access right valid for two cycles to CH4 and an access right valid for four cycles to CH6. The group setting information shown in FIG. 9A coincides with that in the example shown in FIG. 8.

FIG. 9B is a waveform chart showing a case where the access control section 11 grants access rights when there is a master that belongs to the subordinate group. The signals shown in FIG. 9B are the same as those shown in FIG. 63, and no description thereof will be made. Further, the order in which the access control section 11 grants access rights to the masters that belong to the priority group or the ordinary group is the same as that shown in FIG. 6B (tₒ to t₁₀). Therefore, a description will only be made of the order in which the access control section 11 grants access rights to the masters that belong to the subordinate group (t₁₀ to t₁₃). It is assumed that the masters that belong to the priority group or the ordinary group do not issue access requests during the period in which the third group process is being performed (t₁₀ to t₁₃).

The access control section 11 grants CH4 in the subordinate group an access right valid for two cycles based on the weighting information in the third group process. The access control section 11 then grants CH6 in the subordinate group an access right valid for four cycles (t₁₀ to t₁₁). The access control section 11 then repeats the same processes (t₁₁ to t₁₂). After the access process requested by CH6 is completed, the access control section 11 subsequently grants CH4 an access right valid for two cycles (t₁₂ to t₁₃).

As described above, even when the group setting information storage section 10 stores information on the subordinate group, an access request from a master that belongs to the priority group or the ordinary group will be processed without delay. The subordinate group G3 is therefore a group to which a master that issues a low-priority access request is suitably allocated.

### 4. Fourth Embodiment

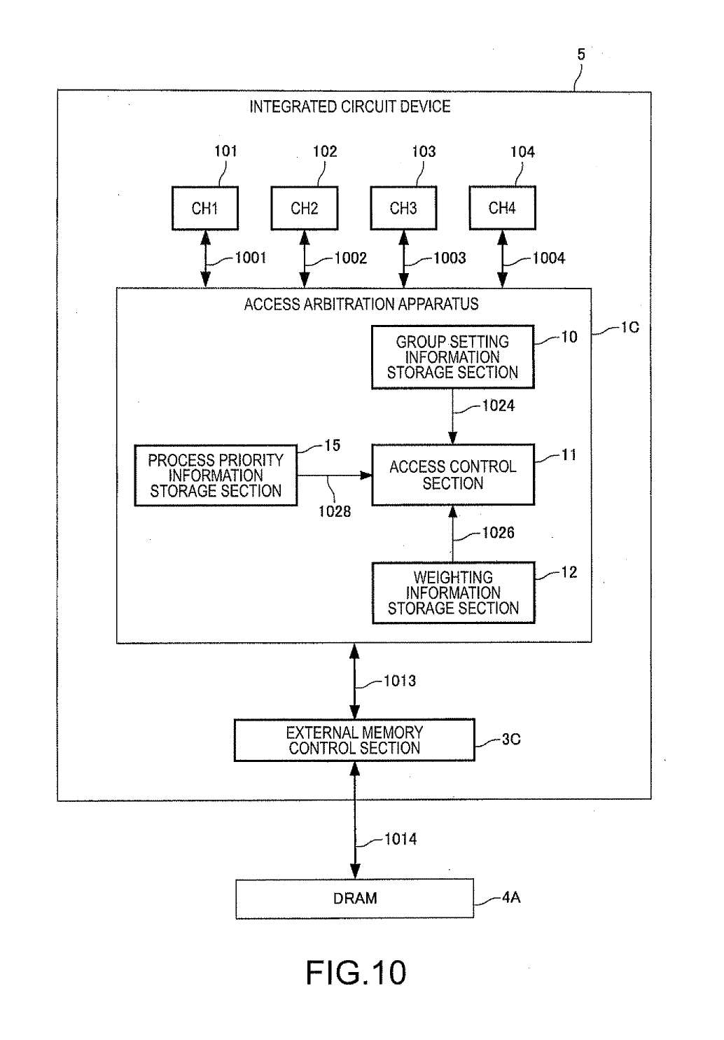

A fourth embodiment of the invention will be described with reference to FIGS. 10, 11, 12, 13A, and 13B. The same components as those in the first to third embodiments have the same reference characters, and no description of these components will be made. Instead, differences between the fourth embodiment and the first to third embodiments will primarily be described.

FIG. 10 is a block diagram including an access arbitration apparatus 1C of the present embodiment. The access arbitration apparatus 1C arbitrates requests from a plurality of masters CH1 to CH4 (101 to 104) for access to a DRAM 4A. The DRAM 4A corresponds to the storage section 4 in the third embodiment. An external memory control section 3C that reads and writes data from and to the DRAM 4A corresponds to the storage control section 3B in the third embodiment. In the present embodiment, CH1 to CH4, the access arbitration apparatus 1C, and the external memory control section 3C form an integrated circuit device 5.

The access arbitration apparatus 1C of the present embodiment includes a process priority information storage section 15 that outputs process priority information 1028 to the access control section 11. The process priority information 1028 contains the relationship between masters and process priorities based on which the order in which access requests are processed is determined.

An access arbitration apparatus can be used not only to prevent signals from a plurality of masters from colliding with each other on a bus but also, for example, to select an output signal in accordance with priority from a plurality of signals inputted to the access arbitration apparatus. The access arbitration apparatus 1C does not input or output signals from and to a bus, unlike the first to third embodiments. Instead, when a plurality of masters out of CH1 to CH4 issue access requests to the access arbitration apparatus 1C (1001, 1002, 1003, 1004), the access arbitration apparatus 1C outputs or inputs a signal necessary for access to or from the external memory control section in accordance with priorities of the access request sources.

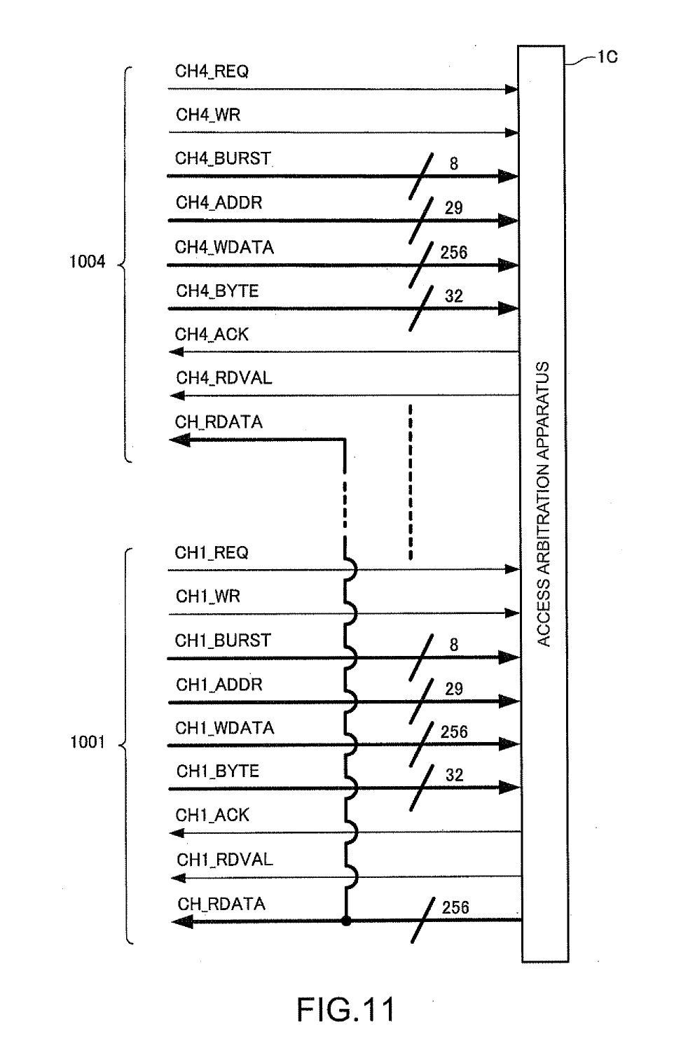

FIG. 11 shows a specific example of input/output signals 1001 to 1004 sent between the access arbitration apparatus 1C and CH1 to CH4. Although signal lines that form the input/output signals 1002 and 1003 are not shown, each of the input/output signals 1002 and 1003 has the same configuration as that of the input/output signal 1001 or 1004. Further, since the input/output signals 1001 and 1004 also have the same signal configuration, only the input/output signal 1001 will be described below. That is, a signal with a prefix CH4_ instead of CH1_ can be described by replacing CH1 with CH4 in the following description.

In FIG. 11, the input/output signal 1001 contains CH1_REQ, CH1_WR, CH1_BURST, CH1_ADDR, CH1_WDATA, CH1_BYTE, CH1_ACK, CH1_RDVAL, and CH_RDATA.

CH1_REQ is an access request signal from CH1. CH1_WR is a signal indicating that the access request from CH1 is a write request to the DRAM 4A. CH1_BURST represents the number of cycles necessary in the access requested by the master (master request cycle).

CH1_ADDR is an address signal. CH1_WDATA is a data signal used in write operation. CH1_BYTE is used to specify an effective portion of CH1_WDATA expressed on a byte basis and written to the DRAM 4A in response to a write request from CH1.

CH1_ACK is a signal sent from the access arbitration apparatus when a requested access process is completed. The ACK signal may alternatively be a signal sent for each cycle after the access arbitration apparatus accepts an access process. CH1_ACK replaces the access grant signal. For example, when a write request is issued to the DRAM 4A, CH1_ACK can inform CH1 that requested data have been written to the DRAM 4A.

CH1_RDVAL is a signal indicating that the access arbitration apparatus outputs the effective data to CH1 through CH_RDATA. CH_RDATA represents data from the DRAM 4A.

For example, when some of the masters CH1 to CH4 issue write requests to the DRAM 4A, address signals (CH1_ADDR and CH4_ADDR, for example) collide with each other and data to be written (CH1_WDATA and CH4_WDATA, for example) collide with each other in the access arbitration apparatus 1C. To solve the problem, the access arbitration apparatus 1C arbitrates the signals related to the write requests from CH1 to CH4 in accordance with priority.

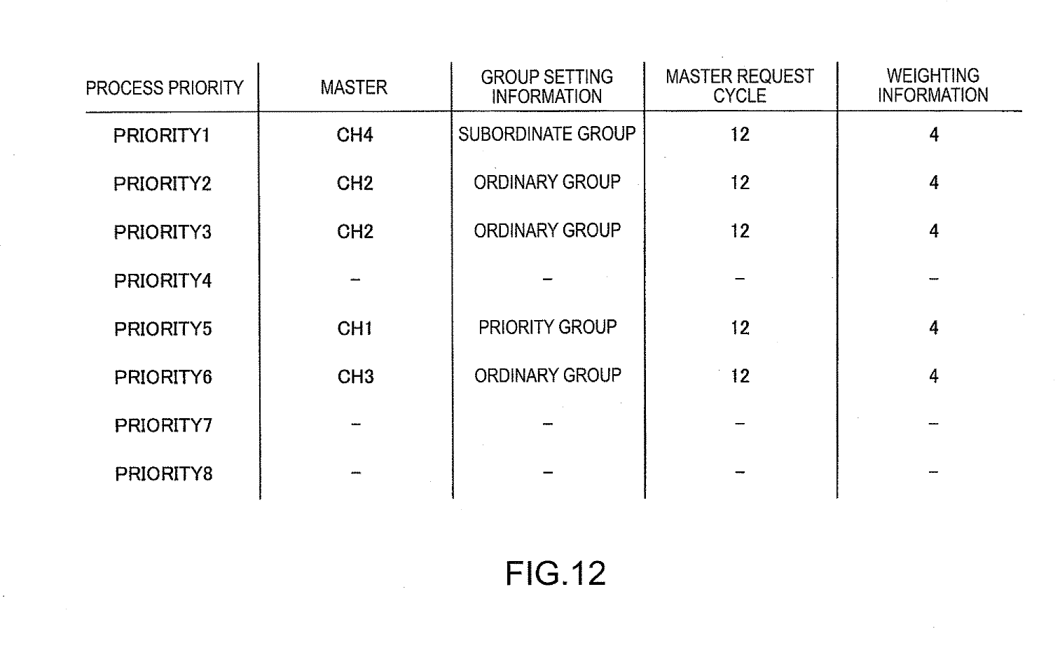

FIG. 12 is a table showing an example of process priorities and corresponding masters. Each of the masters is related to the group to which the master belongs (group setting information), the number of necessary cycles in the access requested by the master (master request cycle), and weighting information, and the contents thereof are shown in the table. The items other than the process priorities are the same as those in the example shown in FIG. 9A, and no description of these items will be made.

In the first to third embodiment, the priorities of the masters in a group are determined by the channel numbers of the masters. It is, however, convenient if the priorities in a group are not fixed but can be set arbitrarily. To this end, process priorities are prepared as process priority information in such a way that the number thereof is greater than or equal to the total number of masters, and the channel numbers of the masters are assigned to the priorities. In the example shown in FIG. 12, eight priorities (PRIORITY 1 to PRIORITY 8) are prepared.

In the first to third embodiments, the access control section 11 compares the channel numbers in a single group and performs processes in ascending order of the channel number. In the present embodiment, the access control section 11 compares the process priorities and performs processes in ascending order of the process priority. The process priorities may be arbitrarily assigned to the masters. For example, process priorities to be assigned are not limited in any of the groups. Further, the process priorities having been assigned to the masters can be changed. Since the process order in a single group can be arbitrarily changed by setting process priorities, processes can be performed in an optimum manner in accordance with the situations.

It is also possible to accept a state in which there is no master corresponding to a certain process priority (empty state) or a state in which a single master is allocated to a plurality of process priorities (overlapping state). For example, there are no masters corresponding to PRIORITY 4, PRIORITY 7, and PRIORITY 8 in the example shown in FIG. 12. The empty state shown in FIG. 12 provides a reserved priority area that can be used to change the priorities in the course of a process. Further, PRIORITY 2 and PRIORITY 3 are assigned to CH2 in the example shown in FIG. 12. In this case, the virtually two masters labeled with CH2 are handled as if each of them were an independent master. That is, in the example shown in FIG. 12, CH2 can acquire an access right two times longer than an access right granted to any of the other masters. The overlapping assignment allows a certain master to acquire an access right N (N=2, 3, . . . ) times longer in time than that granted to other masters. In addition to this, the time over which an access right is granted to a certain master can be minutely set by using weighting information. Further, when weighting information is not dependent on a master but is dependent on a process priority, the time over which an access right is granted to a certain master can be set in a minuter manner. For example, PRIORITY 2 and PRIORITY 3 have the same weighting information of four in the example shown in FIG. 12, but only PRIORITY 2 may have weighting information of a different value, such as eight.

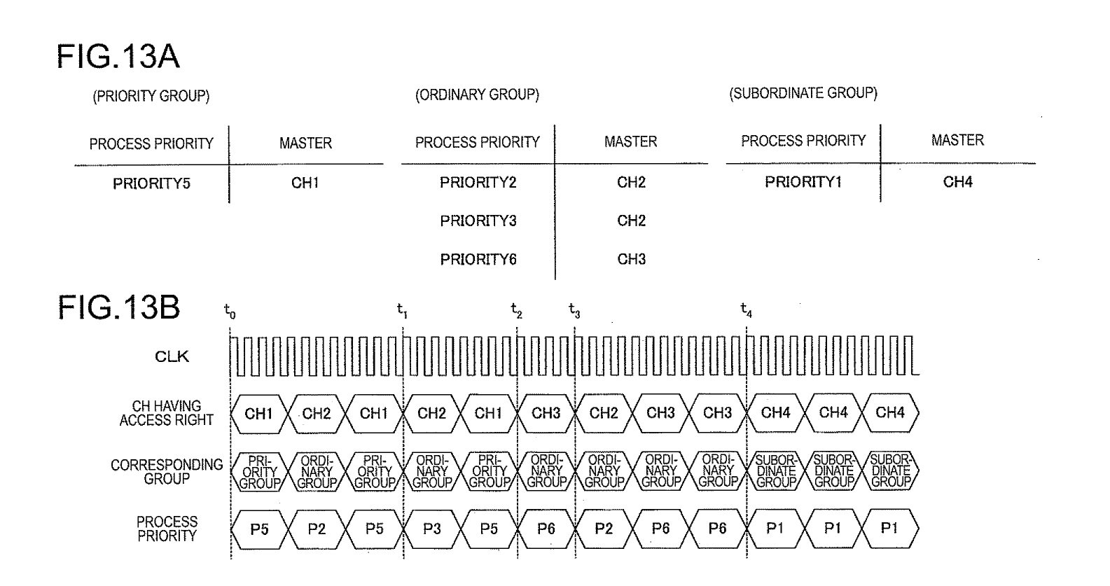

FIG. 13A is a table in which the relationship between the process priorities and the masters in FIG. 12 is separately presented on a group basis. Since CH2 has the highest priority in the ordinary group, and the overlapping assignment has been performed on CH2, CH2 acquires an access right twice, and then CH3 acquires an access right.

FIG. 13B is a waveform chart showing an example of the order in which the access control section 11 grants access rights based on the process priorities. FIG. 13B shows a case where an access right is sequentially granted to a master, and the corresponding process priority is shown in the lowermost portion of the waveform chart. For example, when an access right is granted to CH2, at can be identified as PRIORITY 2 or PRIORITY 3. The abbreviation “P” in FIG. 13B stands for PRIORITY. It is assumed that part of the access request sources in the second group process is a single access request source in the present embodiment as well.

In the present embodiment as well, the first group process, that is, a process for CH1 in the priority group, is first performed. Since only CH1 belongs to the priority group, the process priority does not particularly affect the first group process. The control then proceeds to the ordinary group process. As the second group process, an access request from part of the ordinary group (“one” access request in the present embodiment) is processed. Specifically, the access request is issued from one of the virtually two masters CH2 that has PRIORITY 2, which is the highest process priority in the ordinary group. The first group process is then performed again (t₀ to t₁).

In the subsequent second group process, an access request from CH2 corresponding to the next process priority, that is, PRIORITY 3, is processed (t₁). The access control section 11 handles the two masters that are actually the same based on their process priorities as if there were separate access requests.

After the access control section 11 further performs the first group process, CH3, which belongs to the ordinary group and issues an access request corresponding to PRIORITY 6, is processed (t₂).

Since the process requested by CH1 in the priority group is completed, processes for the ordinary group are performed (t₃ to t₄). When all the processes for the ordinary group are completed, an access request from a master that belongs to the subordinate group is processed (t₄).

As described above, adding the process priority information allows the process order in a single group to be arbitrarily set, and assigning two process priorities to a single master allows the time over which an access right is granted to the master to be increased by a factor of N (N=2, 3, . . . ).

### 5. Fifth Embodiment

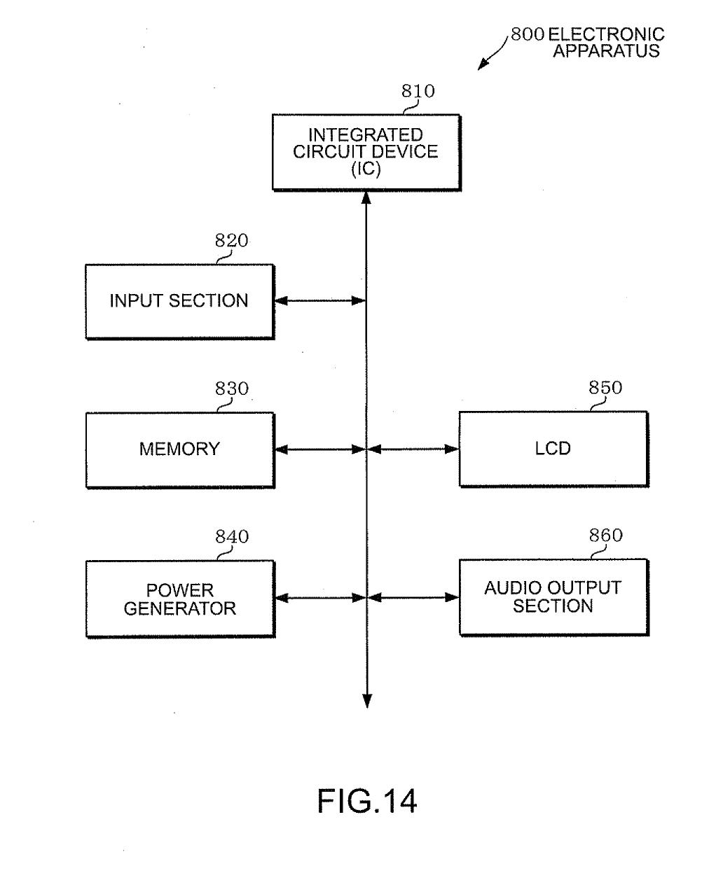

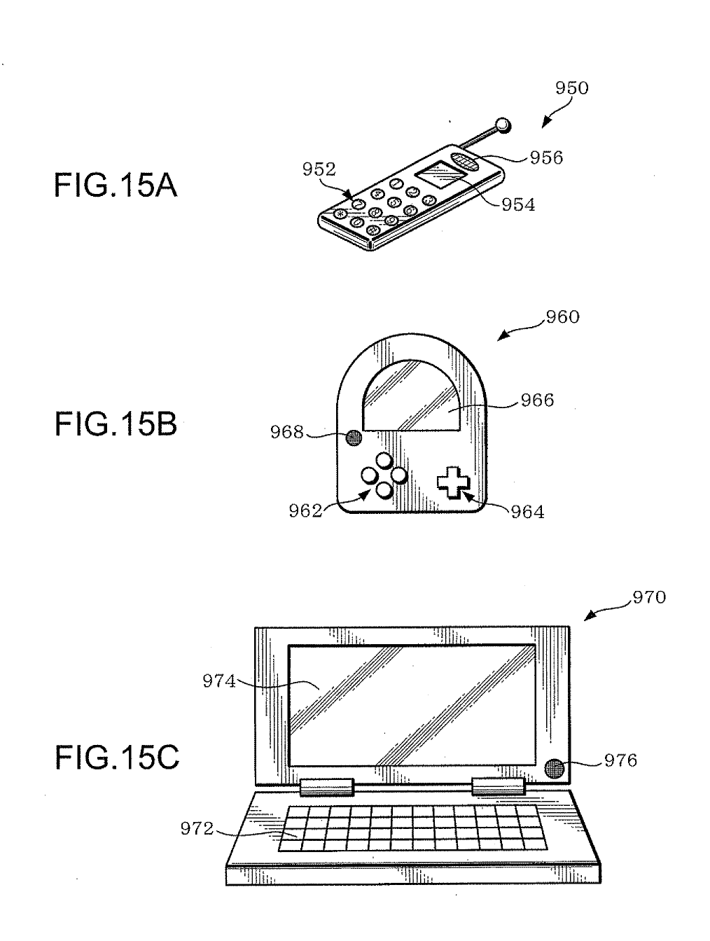

A fifth embodiment of the invention will be described with reference to FIGS. 14, 15A, 15B, and 15C.

FIG. 14 is a block diagram of an electronic apparatus 800 according to the present embodiment. The electronic apparatus 800 includes an integrated circuit device 810, an input section 820, a memory 830, a power generator 840, an LCD 850, and an audio output section 860. The integrated circuit device 810 corresponds to the integrated circuit device 5 in the fourth embodiment. The memory 830 may correspond to the storage section 4 in the first to third embodiments or the DRAM 4A in the fourth embodiment.

The input section 820 is provided to input a variety of data. The integrated circuit device 810 performs a variety of processes based on the data inputted from the input section 820. The memory 830 serves as a work area used by the integrated circuit device 810 and other components. The power generator 840 is provided to generate a variety of power sources used in the electronic apparatus 800. The LCD 850 is provided to output a variety of images (such as characters, icons, and graphics) displayed on the electronic apparatus 800.

The audio output section 860 is provided to output a variety of sounds (such as voices and game sounds) from the electronic apparatus 800, and the function of the audio output section 860 can be achieved by a loud speaker or any other suitable hardware.

FIG. 15A is an exemplary exterior view of a mobile phone 950, which is an electronic apparatus. The mobile phone 950 includes dial buttons 952 that function as the input section, an LCD 954 that displays telephone numbers, names, icons, and other information, and a loud speaker 956 that functions as the audio output section and outputs voices.

FIG. 15B is an exemplary exterior view of a mobile game console 960, which is an electronic apparatus. The mobile game console 960 includes operation buttons 962 that function as the input section, a cross key 964, an LCD 966 that displays game images, and a loud speaker 968 that functions as the audio output section and outputs game sounds.

FIG. 15C is an exemplary exterior view of a personal computer 970, which is an electronic apparatus. The personal computer 970 includes a keyboard 972 that functions as the input section, an LCD 974 that displays characters, numerics, graphics, and other information, and audio output section 976.

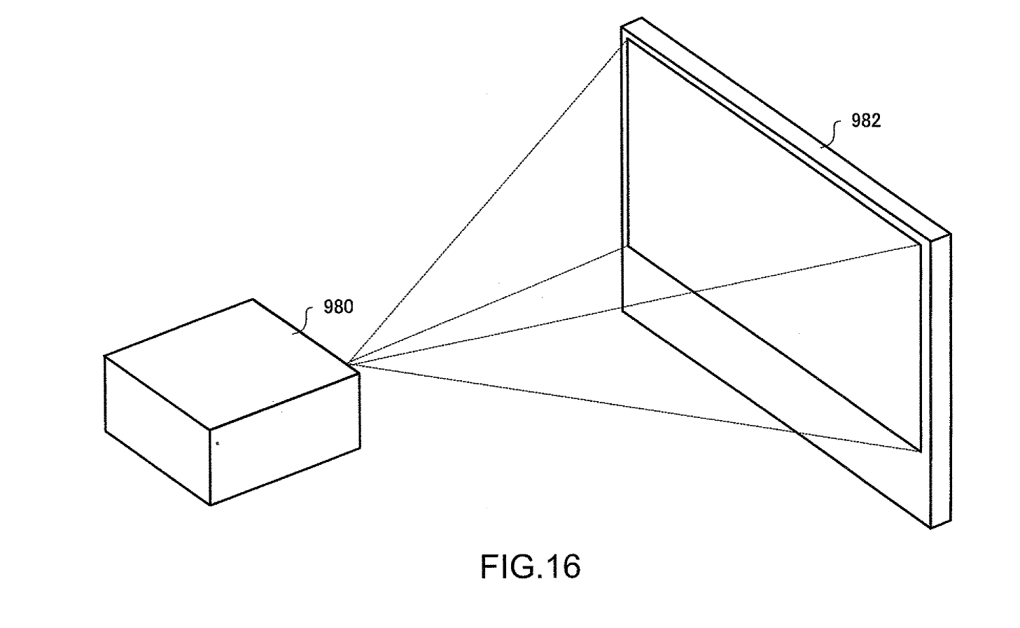

FIG. 16 is an exemplary exterior view of a projector 980, which is an electronic apparatus. The projector 980 projects an image on a screen 982. The projector 980 not only preferentially projects an image but also appropriately handles access to image data in response to user's operation and other requests based on the arbitration described above.

Incorporating the integrated circuit device of the present embodiment into any of the electronic apparatus shown in FIGS. 15A to 15C and 16 allows the electronic apparatus 800 to flexibly change the priorities of requests for access to the memory 830 or other components from a plurality of masters included in the integrated circuit device 810.

### 6. Sixth Embodiment

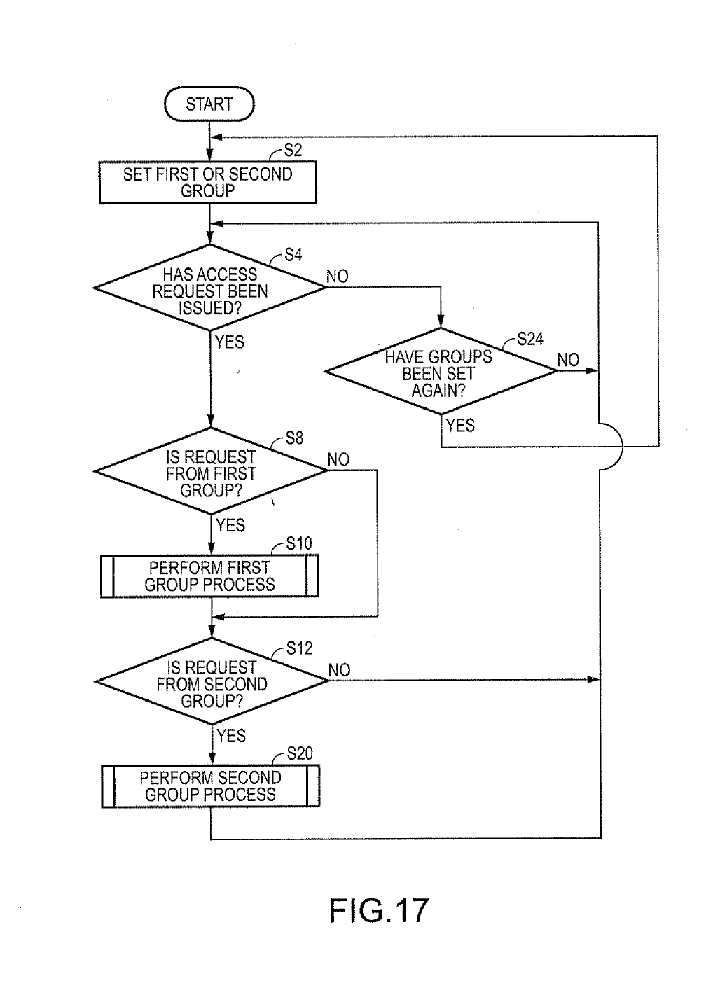

A sixth embodiment of the invention will be described with reference to FIGS. 17, 18, 19A, 19B, and 19C.

A control method used by the access control section 11 to grant an access right in the first to fifth embodiments can be described with reference to the following flowcharts. The control method may be achieved by using hardware or a program along with a controller, such as a CPU.

FIG. 17 is a flowchart showing a control method for granting an access right in a case where masters are allocated to first and second groups based on the group setting information. The first and second groups correspond to the priority and ordinary groups respectively in the embodiments described above.

First, masters are allocated to the first or second group (S2). In this step, the process priorities in the fourth embodiment may alternatively be assigned instead of the masters.

It is then determined whether or not an access request has been issued (S4). When no access request has been issued (N in S4), for example, the group setting information may be updated (Y in S24).

When an access request has been issued, and the access request is from the first group (Y in S8), the first group process is preferentially performed (S10). When the access request is not from the first group (N in S8), the first group process is not performed.

When the access request is from the second group (Y in S12), the second group process is performed (320). When no access request has been issued from the second group, the second group process (S20) is not performed.

The control returns to the state in which the access control section 11 is ready to accept an access request (N in S24, N in S12, and after S20 is completed), and it is determined whether or not an access request has been issued (S4). The steps described above are repeated.

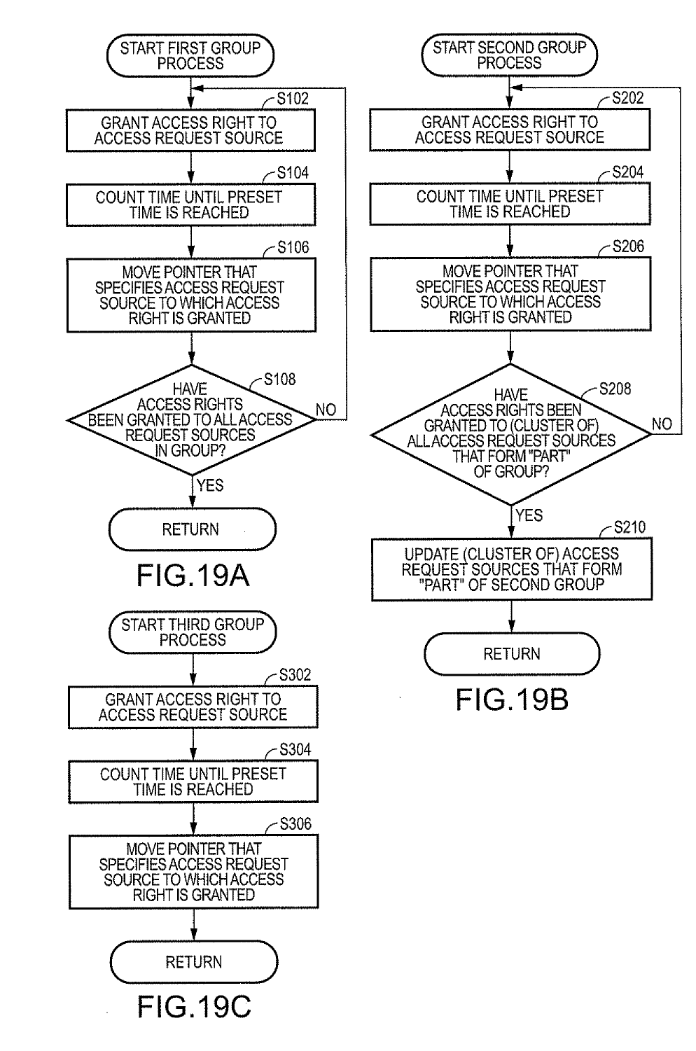

The first group process (S10) is now described with reference to FIG. 19A.

In the first group process, an access right is granted to an access request source selected based, for example, on the process priorities (S102). Time is counted based, for example, on the weighting information until a fixed time is reached, and an access right is kept being granted to the access request source during the counting period (S104).

In the present embodiment, the access request source to which an access right is granted changes with time. Further, the time over which an access right is granted changes differently for each group. It is therefore preferable that each of the groups has a pointer and the pointer specifies an access request source to which an access right is granted. For example, in FIG. 13A, the access control section 11, a program corresponding thereto, or any other component adds a flag indicating an access request source to be processed to the items of the process priorities and the masters, and the flag is changed with time.

The pointer is then moved to specify the next access request source to which an access right is granted (S106). After access rights are granted to all access request sources in a group, the first group process is terminated (Y in S108). Otherwise, an access request source to which no access right has been granted in the group is processed (N in S108).

The second group process (S20) will next be described with reference to FIG. 19B.

After an access right is granted to an access request source specified by the pointer (S202), and time is counted until predetermined time is reached (S204), the pointer is moved (S206). These steps are the same as those in the first group process (S10).

In the second group process, instead of granting access rights to all access request sources in the group, “part” of the group, that is, all access request sources that form a subset in the group, is processed (S208). The “part”, that is, the subset of access request sources, is then updated in preparation for the subsequent second group process (S210). A pointer or a flag may also be used to specify the subset.

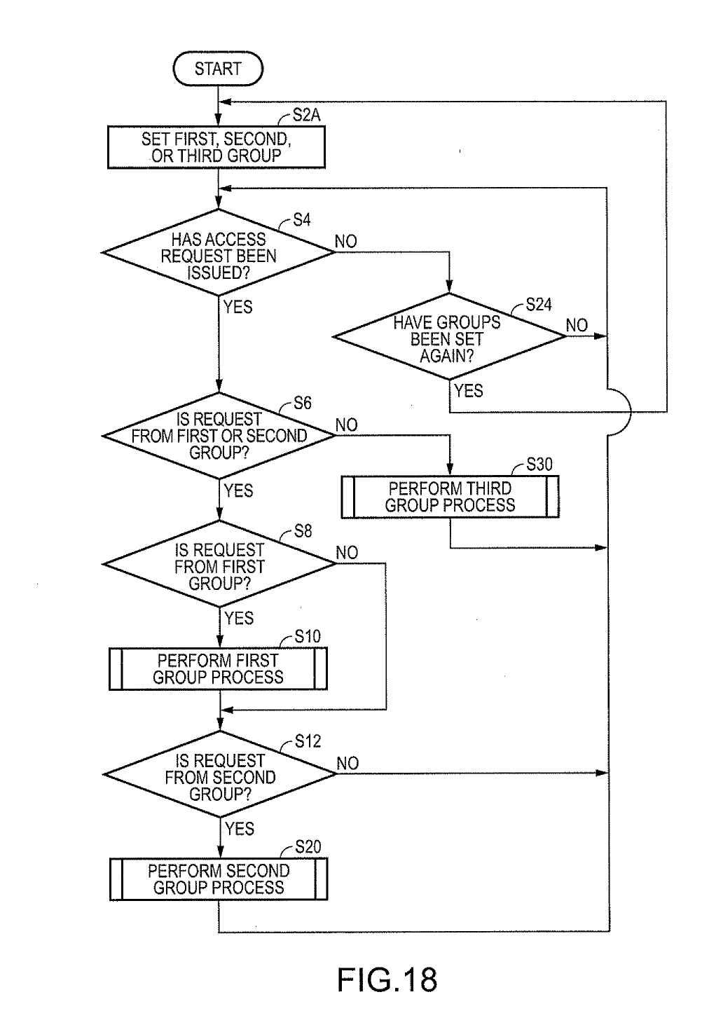

FIG. 18 is a flowchart showing a control method for granting an access right in a case where masters are allocated to not only the first and second groups but also a third group based on the group setting information. The third group corresponds to the subordinate group in the embodiments described above.

FIG. 18 differs from FIG. 17 in that masters are allocated to the first, second, or third group (S2A), and that when an access request has been issued (Y in S4), it is first determined whether the access request is from the first or second group (S6).

The third group process (830) is performed only when no access request has been issued from the first or second group (N in S6).

The third group process (830) will now be described with reference to FIG. 19C.

In the third group process as well, after an access right is granted to an access request source specified by the pointer (S302), and time is counted until predetermined time is reached (S304), the pointer is moved (S306). These steps are the same as those in the first group process (S10) and the second group process (S20).

The third group process, however, differs from the first and second group processes in that once an access right is granted to an access request source in the third group, the subsequent third group process (830) is performed only when no access request has been issued from the first or second group (S6), whose priority is higher than that of the third group.

The invention is not limited to the embodiments described above but encompasses a configuration that is substantially the same as any of the configurations described with reference to the embodiments (for example, a configuration that provides the same function, method, and result or a configuration that achieves the same purpose and effect). The invention further encompasses a configuration in which a portion that is not essential in the configuration described with reference to any of the embodiments is replaced. The invention further encompasses a configuration that provides the same advantageous effect or achieves the same purpose as that provided by any of the configurations described with reference to the embodiments. The invention further encompasses a configuration obtained by adding a known technology to any of the configurations described with reference the embodiments.

What is claimed is:

1. An access arbitration apparatus comprising:
a group setting information storage section; and
an access control section,
the group setting information storage section storing group setting information that specifies which of the following groups each of a plurality of masters belongs to, a first group or a second group whose priority is lower than that of the first group, and
the access control section identifying an access request source, which is a master that is requesting an access right, based on an access request signal from each of the plurality of masters,
identifying which of the following access request source set the access request source belongs to based on the group setting information, a first access request source set that belongs to the first group and a second access request source set that belongs to the second group, and
repeatedly performing a first group process and a second group process in an alternate manner, the first group process being a process of granting access rights valid for predetermined time to the entire first access request source set, the second group process being a process of granting access rights valid for predetermined time to part of the second access request source set.

2. The access arbitration apparatus according to claim 1,
the access control section granting an access right valid for predetermined time to one of the access request sources in the second access request source set in the second group process.

3. The access arbitration apparatus according to claim 1,
further comprising a weighting information storage section,
the weighting information storage section storing weighting information that specifies the time over which an access right is granted to the access request source, and
the access control section adjusts the time over which an access right is granted to the access request source based on the weighting information.

4. The access arbitration apparatus according to claim 1,
the group setting information storage section storing group setting information that specifies which of the following groups each of the plurality of masters belongs to, the first group, the second group, or a third group whose priority is lower than that of the second group, and
the access control section identifying which of the following access request source set the access request source belongs to based on the group setting information, the first access request source set, the second access request source set, or a third access request source set that belongs to the third group, and
repeatedly performing a third group process of granting access rights valid for predetermined time to the third access request source set only when an access request source that belongs to the first access request source set or the second access request source set is not present.

5. The access arbitration apparatus according to claim 1,
further comprising a group setting section,
the group setting section setting the group setting information.

6. The access arbitration apparatus according to claim 1,
further comprising a weighting setting section,
the weighting setting section setting the weighting information.

7. The access arbitration apparatus according to claim 1,
further comprising a process priority information storage section,
the process priority information storage section storing process priority information that relates one or more of the plurality of masters to process priorities the number of which is greater than or equal to the total number of the plurality of masters, and
the access control section determines the order in which the access request source that belong to a single group are processed based on the process priority information.

8. The access arbitration apparatus according to claim 7,
the weighting information being so set that the weighting information is related to the process priorities, and
the access control section adjusts the time over which an access right is granted to the access request source based on the weighting information that is so set that the weighting information is related to the process priorities.

9. An integrated circuit device comprising the access arbitration apparatus according to claim 1.

10. An electronic apparatus comprising the integrated circuit device according to claim 9.

11. An access arbitration method comprising:
a group setting step of setting group setting information that specifies which of the following groups each of a plurality of masters belongs to, a first group or a second group whose priority is lower than that of the first group;
an identification step of identifying an access request source, which is a master that is requesting an access right, based on an access request signal from each of the plurality of masters;
a group identification step of identifying which of the following access request source set the access request source belongs to based on the group setting information, a first access request source set that belongs to the first group and a second access request source set that belongs to the second group; and
a group process step of repeatedly performing a first group process and a second group process in an alternate manner, the first group process being a process of granting access rights valid for predetermined time to the entire first access request source set, the second group process being a process of granting access rights valid for predetermined time to part of the second access request source set.

12. The access arbitration method according to claim 11,
the group setting step setting group setting information that specifies which of the following groups each of the plurality of masters belongs to, the first group, the second group, or a third group whose priority is lower than that of the second group,
the group identification step identifying which of the following access request source set the access request source belongs to based on the group setting information, the first access request source set, the second access request source set, or a third access request source set that belongs to the third group, and
the group process step repeatedly performing a third group process of granting access rights valid for predetermined time to the third access request source set only when an access request source that belongs to the first access request source set or the second access request source set is not present.

13. An access arbitration program that allows a computer to function as:
a storage unit that stores group setting information that specifies which of the following groups each of a plurality of masters belongs to, a first group or a second group whose priority is lower than that of the first group; and
an access control unit that identifies an access request source, which is a master that is requesting an access right, based on an access request signal from each of the plurality of masters,
identifying which of the following access request source set the access request source belongs to based on the group setting information, a first access request source set that belongs to the first group and a second access request source set that belongs to the second group,
repeatedly performing a first group process and a second group process in an alternate manner, the first group process being a process of granting access rights valid for predetermined time to the entire first access request source set, the second group process being a process of granting access rights valid for predetermined time to part of the second access request source set, and
granting the access request source an access right.

14. The program according to claim 13,
the storage unit, that stores the group setting information, specifying which of the following groups each of the plurality of masters belongs to, the first group, the second group, or a third group whose priority is lower than that of the second group, and
the access control unit identifying which of the following access request source set the access request source belongs to based on the group setting information, the first access request source set, the second access request source set, or a third access request source set that belongs to the third group, and
repeatedly performing a third group process of granting access rights valid for predetermined time to the third access request source set only when an access request source that belongs to the first access request source set or the second access request source set is not present.
